(19) United States
(12) Patent Application Publication
(10) Pub. No.: US 2018/0047173 A1
(43) Pub. Date: Feb. 15, 2018

(54) METHODS AND SYSTEMS OF PERFORMING CONTENT-ADAPTIVE OBJECT TRACKING IN VIDEO ANALYTICS

(71) Applicant: QUALCOMM Incorporated, San Diego, CA (US)

(72) Inventors: Lei Wang, Clovis, CA (US); Ying Chen, San Diego, CA (US); Jian Wei, San Diego, CA (US); Jinglun Gao, Milpitas, CA (US); Chinchuan Chiu, Poway, CA (US)

(21) Appl. No.: 15/382,244

(22) Filed: Dec. 16, 2016

Related U.S. Application Data
(60) Provisional application No. 62/374,406, filed on Aug. 12, 2016.

(51) Int. Cl. G06T 7/246; G06T 7/62; G06T 7/136; G06T 7/194

(52) U.S. Cl. CPC G06T 7/246; G06T 7/194; G06T 7/62; G06T 7/136; G06T 2207/30232; G06T 2207/10016; G06T 2207/20224; G06T 2207/20036

(57) ABSTRACT

Techniques and systems are provided for processing video data. For example, techniques and systems are provided for performing content-adaptive object or blob tracking. To perform the content-adaptive object tracking, a blob tracker is associated with a blob generated for a video frame. The blob includes pixels of at least a portion of a foreground object in a video frame. A size of the blob can be determined to be greater than a blob size threshold. The blob tracker can be converted to a normal tracker based on the size of the blob being greater than the size threshold. The associated blob tracker and blob are output as an identified blob tracker-blob pair when the blob tracker is converted to the normal tracker.

### CROSS-REFERENCE TO RELATED APPLICATIONS

This application claims the benefit under 35 U.S.C. § 119 of Provisional Patent Application Number 62/374,406, filed on August 12, 2016, the entirety of which is incorporated by reference herein.

### FIELD

The present disclosure generally relates to video analytics, and more specifically to techniques and systems performing object detection and tracking in video analytics.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. In some cases, video analytics can send alerts or alarms for certain events of interest. More advanced video analytics is needed to provide efficient and robust video sequence processing.

### BRIEF SUMMARY

In some embodiments, techniques and systems are described for performing content-adaptive object (or blob) tracking in video analytics. For example, a blob generated for a video frame can be tracked in a content-adaptive manner based on a size of the blob, based on sizes of a blob tracker used to track one or more blobs in one or more previous frames, based on an amount of time the blob tracker has been active, or any combination thereof. A blob represents at least a portion of an object in a video frame (also referred to as a “picture”).

In some examples, using video analytics, background subtraction is applied to one or more frames of captured video and a foreground-background binary mask (referred to herein as a foreground mask) is generated for each frame. In some cases, morphology operations can be applied to a foreground mask of a frame to reduce noise present in the foreground mask. Connected component analysis can be performed (after background subtraction or after morphology operations) to generate connected components from the foreground mask. Blobs may then be identified for the current frame based on the connected components. The blobs can be provided, for example, for blob processing, object tracking, and other video analytics functions.

In some cases, the blobs can be used for temporal object tracking. For example, costs between blob trackers and blobs can be calculated, and data association can performed to associate the trackers with the blobs based on the costs. A new tracker starts to be associated with a blob in one frame, and may be connected with possibly moving blobs across one or more subsequent frames. When a tracker has been continuously associated with blobs and a duration has passed, the tracker can be promoted or converted to be a normal tracker. A normal tracker is output as an identified tracker-blob pair to the video analytics system. The content-adaptive object tracking techniques and systems described herein can be used to convert trackers associated with large blobs to normal trackers more quickly than those associated with blobs that are not considered large. Techniques and systems are also described for adaptively assigning costs to tracker-blob pairs based on size changes of blobs across video frames.

According to at least one example of performing content-adaptive object tracking, a method of tracking one or more blobs is provided that includes associating a blob tracker with a blob generated for a video frame. The blob includes pixels of at least a portion of a foreground object in a video frame. The method further includes determining a size of the blob. The method further includes determining the size of the blob is greater than a blob size threshold. The method further includes converting the blob tracker to a normal tracker based on the size of the blob being greater than the size threshold. The associated blob tracker and blob are output as an identified blob tracker-blob pair when the blob tracker is converted to the normal tracker.

In another example of performing content-adaptive object tracking, an apparatus is provided that includes a memory configured to store video data and a processor. The processor is configured to and can associate a blob tracker with a blob generated for a video frame. The blob includes pixels of at least a portion of a foreground object in a video frame. The processor is further configured to and can determine a size of the blob. The processor is further configured to and can determine the size of the blob is greater than a blob size threshold. The processor is further configured to and can convert the blob tracker to a normal tracker based on the size of the blob being greater than the size threshold. The associated blob tracker and blob are output as an identified blob tracker-blob pair when the blob tracker is converted to the normal tracker.

In another example of performing content-adaptive object tracking, a computer readable medium is provided having stored thereon instructions that when executed by a processor perform a method that includes: associating a blob tracker with a blob generated for a video frame, wherein the blob includes pixels of at least a portion of a foreground object in a video frame; determining a size of the blob; determining the size of the blob is greater than a blob size threshold; and converting the blob tracker to a normal tracker based on the size of the blob being greater than the size threshold, wherein the associated blob tracker and blob are output as an identified blob tracker-blob pair when the blob tracker is converted to the normal tracker.

In another example of performing content-adaptive object tracking, an apparatus is provided that includes means for associating a blob tracker with a blob generated for a video frame. The blob includes pixels of at least a portion of a foreground object in a video frame. The apparatus further comprises means for determining a size of the blob. The apparatus further comprises means for determining the size of the blob is greater than a blob size threshold. The apparatus further comprises means for converting the blob tracker to a normal tracker based on the size of the blob being greater than the size threshold. The associated blob tracker and blob are output as an identified blob tracker-blob pair when the blob tracker is converted to the normal tracker.

In some aspects of performing content-adaptive object tracking, the methods, apparatuses, and computer readable medium described above further comprise: determining a location history of the blob tracker, wherein the location history includes one or more locations of one or more bounding boxes associated with the blob tracker in one or more previous video frames; determining a union of the one or more bounding boxes at the one or more locations; determining a size of the union of the one or more bounding boxes at the one or more locations is greater than a union size threshold; and converting the blob tracker to the normal tracker based on the size of the blob being greater than the size threshold and the size of the union of the one or more bounding boxes being greater than the union size threshold.

In some aspects of performing content-adaptive object tracking, the blob size threshold includes a fraction of a frame size. In some examples, the union size threshold is larger than the blob size threshold.

In some aspects of performing content-adaptive object tracking, the blob tracker includes a new tracker. In some aspects, the blob tracker includes a split-new tracker, the split-new tracker being split from a parent blob tracker.

In some aspects of performing content-adaptive object tracking, the methods, apparatuses, and computer readable medium described above further comprise: determining a duration the blob tracker has been active; determining the duration is greater than an accelerated threshold duration; and converting the blob tracker to the normal tracker based on the size of the blob being greater than the size threshold, the size of the union of the one or more bounding boxes being greater than the union size threshold, and the number of video frames being greater than the accelerated threshold duration. In some aspects, the accelerated threshold duration is a fraction of a threshold duration for converting blob trackers with sizes not greater than the blob size threshold to normal trackers.

In some aspects of performing content-adaptive object tracking, the methods, apparatuses, and computer readable medium described above further comprise: determining a duration the blob tracker has been active; determining the duration is greater than a modified threshold duration; and converting the blob tracker to the normal tracker based on the size of the blob being greater than the size threshold and the number of video frames being greater than the modified threshold duration. In some aspects, the modified threshold duration is a fraction of a threshold duration for converting blob trackers with sizes not greater than the blob size threshold to normal trackers.

According to at least one example of assigning costs to tracker-blob pairs, a method of determining costs between blob trackers and blobs is provided that includes detecting a blob in a video frame. The blob includes pixels of at least a portion of a foreground object. The method further includes determining a size of an intersecting region between a first bounding box associated with a blob tracker and a second bounding box associated with the blob. The method further includes determining a size of a union region. The union region includes a union of the first bounding box and the second bounding box. The method further includes determining a size ratio. The size ratio includes a ratio between the size of the intersecting region and the size of the union region. The method further includes assigning a cost between the blob tracker and the blob based on the size ratio. The costs between the blob trackers and the blobs are used to associate one or more of the blob trackers with one or more of the blobs.

In another example of assigning costs to tracker-blob pairs, an apparatus is provided that includes a memory configured to store video data and a processor. The processor is configured to and can detect a blob in a video frame. The blob includes pixels of at least a portion of a foreground object. The processor is further configured to and can determine a size of an intersecting region between a first bounding box associated with a blob tracker and a second bounding box associated with the blob. The processor is further configured to and can determine a size of a union region. The union region includes a union of the first bounding box and the second bounding box. The processor is further configured to and can determine a size ratio. The size ratio includes a ratio between the size of the intersecting region and the size of the union region. The processor is further configured to and can assign a cost between the blob tracker and the blob based on the size ratio. The costs between the blob trackers and the blobs are used to associate one or more of the blob trackers with one or more of the blobs.

In another example of assigning costs to tracker-blob pairs, a computer readable medium is provided having stored thereon instructions that when executed by a processor perform a method that includes: detecting a blob in a video frame, wherein the blob includes pixels of at least a portion of a foreground object; determining a size of an intersecting region between a first bounding box associated with a blob tracker and a second bounding box associated with the blob; determining a size of a union region, the union region including a union of the first bounding box and the second bounding box; determining a size ratio, wherein the size ratio includes a ratio between the size of the intersecting region and the size of the union region; and assigning a cost between the blob tracker and the blob based on the size ratio, wherein the costs between the blob trackers and the blobs are used to associate one or more of the blob trackers with one or more of the blobs.

In another example of assigning costs to tracker-blob pairs, an apparatus is provided that includes means for detecting a blob in a video frame. The blob includes pixels of at least a portion of a foreground object. The apparatus further comprises means for determining a size of an intersecting region between a first bounding box associated with a blob tracker and a second bounding box associated with the blob. The apparatus further comprises means for determining a size of a union region. The union region includes a union of the first bounding box and the second bounding box. The apparatus further comprises means for determining a size ratio. The size ratio includes a ratio between the size of the intersecting region and the size of the union region. The apparatus further comprises means for assigning a cost between the blob tracker and the blob based on the size ratio. The costs between the blob trackers and the blobs are used to associate one or more of the blob trackers with one or more of the blobs.

In some aspects of assigning costs to tracker-blob pairs, the methods, apparatuses, and computer readable medium described above further comprise: determining the size ratio is less than a size change threshold; and assigning the cost as a maximum cost value, the maximum cost value preventing the blob tracker from being associated with the blob.

In some aspects of assigning costs to tracker-blob pairs, the methods, apparatuses, and computer readable medium described above further comprise: determining the size ratio is greater than a size change threshold; determining a physical distance between the blob tracker and the blob; assigning the cost as the determined distance; and associating the blob tracker with the blob based on the cost.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a block diagram illustrating an example of a system including a video source and a video analytics system, in accordance with some embodiments.

FIG. 2 is an example of a video analytics system processing video frames, in accordance with some embodiments.

FIG. 3 is a block diagram illustrating an example of a blob detection engine, in accordance with some embodiments.

FIG. 4 is a block diagram illustrating an example of an object tracking engine, in accordance with some embodiments.

FIG. 5 is a block diagram illustrating an example of a blob tracker update engine, in accordance with some embodiments.

FIG. 6 is a block diagram illustrating an example of an object tracking engine, in accordance with some embodiments.

FIG. 7 is a diagram illustrating an example of an intersection and union of two bounding boxes, in accordance with some embodiments.

FIG. 8 is a flowchart illustrating an embodiment of a content-adaptive blob tracking process, in accordance with some embodiments.

FIG. 9 is a flowchart illustrating an example of a huge blob conversion technique of the content-adaptive blob tracking process, in accordance with some embodiments.

FIG. 10 is a flowchart illustrating an example of a big blob conversion technique of the content-adaptive blob tracking process, in accordance with some embodiments.

FIG. 11A is an illustration of a video frame (or picture) of an environment in which a huge object is present.

FIG. 11B is an illustration of a video frame with the huge object being tracked.

FIG. 11C is an illustration of another video frame with the huge object being tracked.

FIG. 12A is an illustration of a video frame of an environment in which a big object is present and is being tracked along with another object.

FIG. 12B is an illustration of a video frame with the big object being tracked with a split-new tracker.

FIG. 13 is a flowchart illustrating an example of a process of performing content-adaptive blob tracking, in accordance with some embodiments.

FIG. 14 is a flowchart illustrating another example of a process of determining costs between blobs and trackers, in accordance with some embodiments.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a video sequence from a video source and can process the video sequence to provide a variety of tasks. One example of a video source can include an Internet protocol camera (IP camera), or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of event of interest and sends an alert or alarm to a central control room to alert a user of the event of interest.

As noted previously, video analytics can generate and detect foreground blobs that can be used to perform various operations, such as object tracking or other operations described above. New objects can enter the scene, and objects present in the scene can split into multiple objects (e.g., a driver exits a car). Each of these new objects can be detected as a foreground blob. When a blob is newly identified in a particular input video frame, a video analytics system may generate a new tracker, and start associating the new tracker with a blob from the particular input video frame. The system may further connect the new tracker with blobs across one or more subsequent frames.

Sometimes, a video analytics system may identify noise, moving background objects, and/or encoding artifacts as blobs. In most cases, such blobs should not be tracked. Hence, when the video analytics system has generated a new tracker, the system may was a duration of time or of video frames, and monitor whether the new tracker has been continuously associated with blobs during the duration. When the new tracker has been continuously associated with blobs and a duration has passed, the tracker can be converted to be a normal tracker. Additionally the tracker, and blobs associated with the tracker, can be output as an identified tracker-blob pair to the video analytics system.

In some cases, however, the duration may be too long to properly track some objects. For example, a moving object may be very large, due to being close to the camera, and may move out of the frame before a new tracker associated with the object is converted to a normal tracker. As another example, a large object may split from another object, and until the duration has passed, the large object may not be tracked. As another example, a large object in the scene may be mapped to small blobs due to, for example, segmentation errors, which can cause the object to be identified as multiple small blobs. In each of these examples, object tracking may be less accurate.

Systems and methods are described herein for performing content-adaptive object tracking for converting trackers associated with huge blobs and big blobs to normal trackers more quickly than for blobs that are not considered large. In various implementations, these systems and methods can include identifying huge blobs and big blobs based on one or more size thresholds. In various implementations, the techniques described herein can also include identifying an unusual change in the size of an object, which can be used, for example, to identify large objects that have been segmented into smaller objects. Systems and methods are also described for adaptively assigning costs to tracker-blob pairs based on size changes of blobs across video frames.

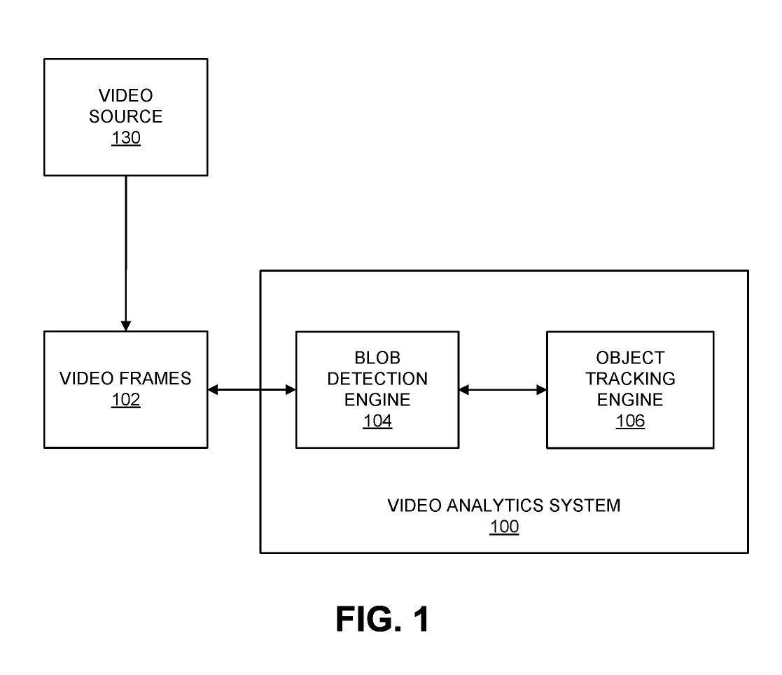

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection engine 104 and an object tracking engine 106. Object detection and tracking allows the video analytics system 100 to provide various features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection engine 104 can detect one or more blobs in video frames (e.g., video frames 102) of a video sequence, and the object tracking engine 106 can track the one or more blobs across the frames of the video sequence. As used herein, a blob refers to pixels of at least a portion of an object in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob.

As described in more detail below, blobs can be tracked using blob trackers. A blob tracker can be associated with a tracker bounding box. In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states and a location for the blob tracker, as described in more detail below.

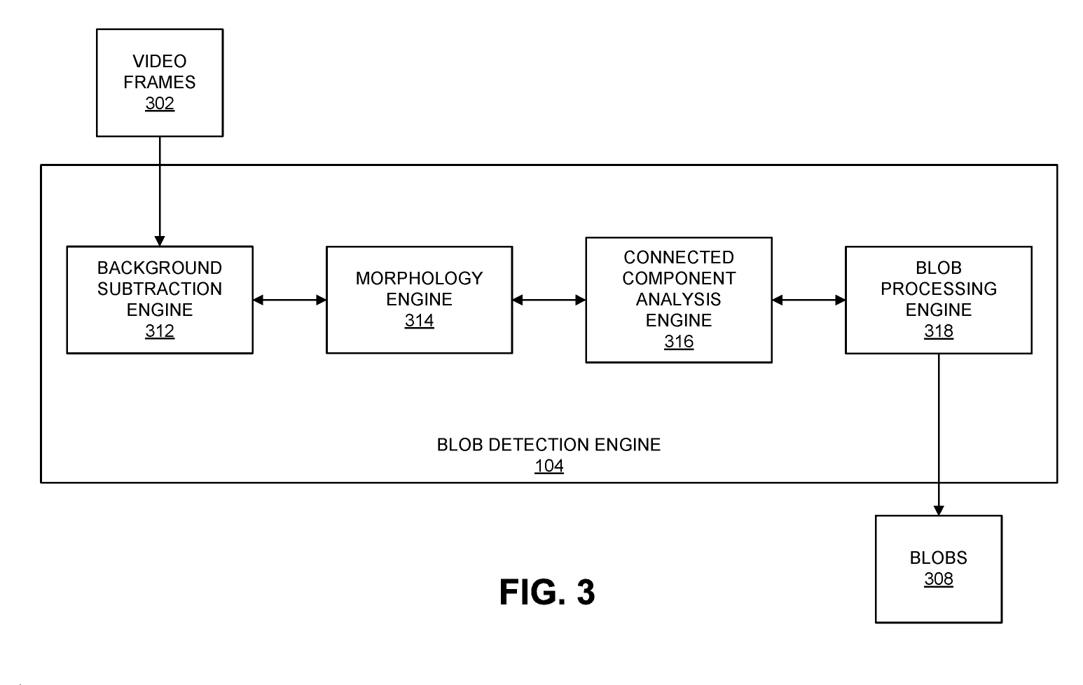

Using the blob detection engine 104 and the object tracking engine 106, the video analytics system 100 can perform blob generation and detection for each frame or picture of a video sequence. For example, the blob detection engine 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection engine 104 and the object tracking engine 106 are described with respect to FIGS. 3-6.

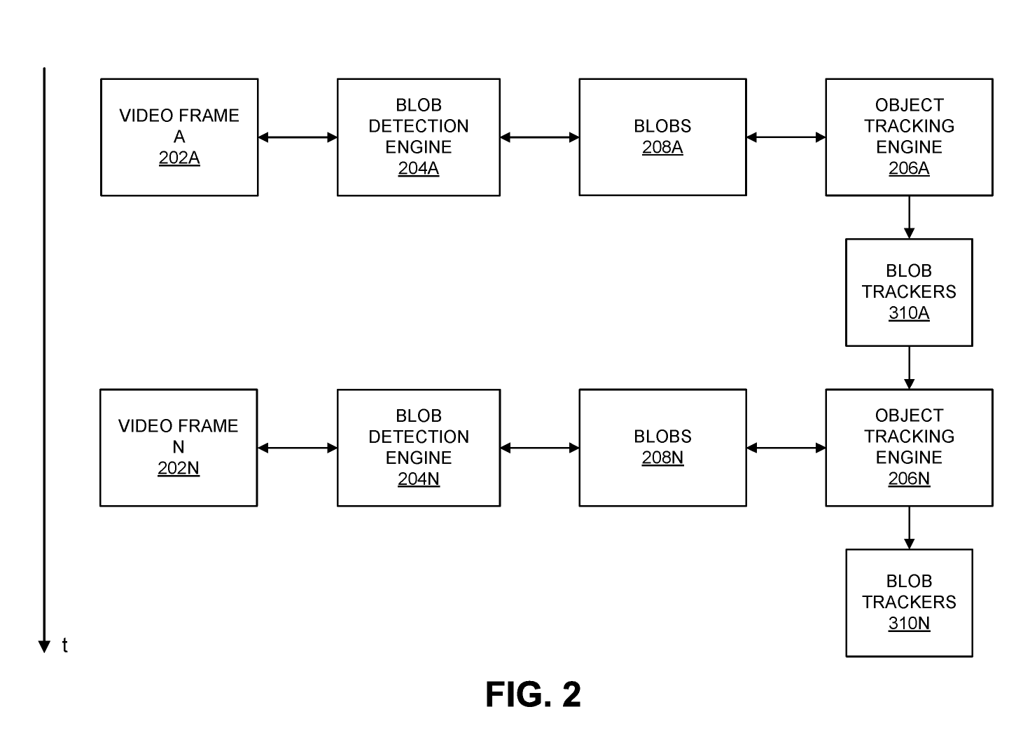

FIG. 2 is an example of the video analytics system (e.g., video analytics system 100) processing video frames across time t. As shown in FIG. 2, a video frame A 202A is received by a blob detection engine 204A. The blob detection engine 204A generates foreground blobs 208A for the current frame A 202A. After blob detection is performed, the foreground blobs 208A can be used for temporal tracking by the object tracking engine 206A. Costs (e.g., a cost including a distance, a weighted distance, or other cost) between blob trackers and blobs can be calculated by the object tracking engine 206A. The object tracking engine 206A can perform data association to associate the blob trackers (e.g., blob trackers generated or updated based on a previous frame or newly generated blob trackers) and blobs 208A using the calculated costs (e.g., using a cost matrix or other suitable association technique). The blob trackers can be updated according to the data association to generate updated blob trackers 310A. For example, a blob tracker's state and location for the video frame A 202A can be calculated and updated. The blob trackers location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection engine 204N generates foreground blobs 208N for the frame N 202N. The object tracking engine 206N can then perform temporal tracking of the blobs 208N. For example, the object tracking engine 206N obtains the blob trackers 310A that were updated based on the prior video frame A 202A. The object tracking engine 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection engine 104. Blob detection is used to segment moving objects from the global background in a video sequence. The blob detection engine 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (GMM). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

$$P ( {X}_{t} ) = {\sum }_{i = 1}^{K} {ω}_{i , t} N ( {X}_{t} \vert {μ}_{i , t} , {Σ}_{i , t} ) \qquad Equation ( 1 )$$

An equation of the GMM model is shown in equation (1), wherein there are K Gaussian models. Each Guassian model has a distribution with a mean of μ and variance of Σ, and has a weight ω. Here, i is the index to the Gaussian model and t is the time instance. As shown by the equation, the parameters of the GMM changes over time after one frame (at time t) is processed.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with 3×3 window size is called first, and three function calls of dilation of 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. One example of the connected component analysis performed by the connected component analysis engine 316 is implemented as follows:

for each pixel of the foreground mask {
-if it is a foreground pixel and has not been processed, the following
steps apply:

-Apply FloodFill function to connect this pixel to other

foreground and generate a connected component

-Insert the connected component in a list of connected
component.
-Mark the pixels in the connected component as being processed
}

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection engine 104. In some examples, the blob processing engine 318 can perform content-based filtering of certain blobs. For instance, a machine learning method can determine that a current blob contains noise (e.g., foliage in a scene). Using the machine learning information, the blob processing engine 318 can determine the current blob is a noisy blob and can remove it from the resulting blobs that are provided to the object tracking engine 106. In some examples, the blob processing engine 318 can merge close blobs into one big blob to remove the risk of having too many small blobs that could belong to one object. In some examples, the blob processing engine 318 can filter out one or more small blobs that are below a certain size threshold (e.g., an area of a bounding box surrounding a blob is below an area threshold). In some embodiments, the blob detection engine 104 does not include the blob processing engine 318, or does not use the blob processing engine 318 in some instances. For example, the blobs generated by the connected component analysis engine 316, without further processing, can be input to the object tracking engine 106 to perform blob and/or object tracking.

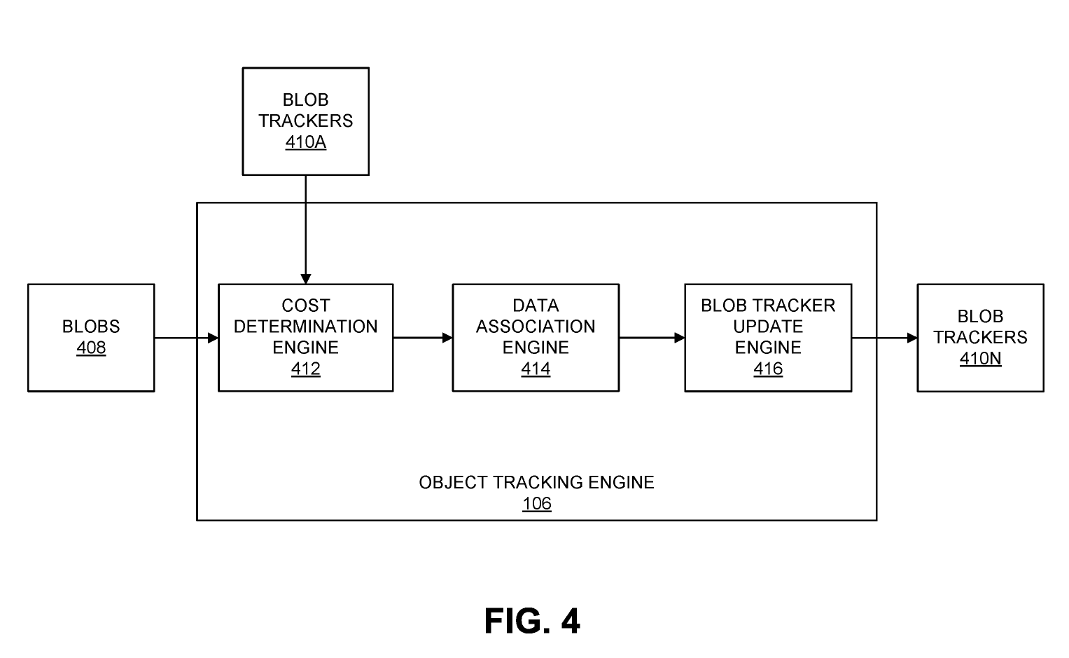

FIG. 4 is a block diagram illustrating an example of an object tracking engine 106. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking engine 106 can obtain the blobs 408 of a current video frame from the blob detection engine 104. The cost determination engine 412 can also obtain the blob trackers 410A updated from the previous video frame (e.g., video frame A 202A). A cost function can then be used to calculate costs between the object trackers 410A and the blobs 408. In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, is based on the determined costs. The data association engine 414 assigns a tracker with a corresponding blob and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

Once the association between the blob trackers 410A and blobs 408 has been completed, the blob tracker update engine 416 can use the information of the associated blobs, as well as the trackers' temporal statuses, to update the states of the trackers 410A for the current frame. Upon updating the trackers 410A, the blob tracker update engine 416 can perform object tracking using the updated trackers 410N, and can also provide the update trackers 410N for use for a next frame.

The state of a blob tracker can includes the tracker's current location in a current frame and its predicted location in the next frame. The state can also, or alternatively, include a tracker's temporal status. The temporal status can include whether the tracker is a new tracker that was not present before the current frame, whether the tracker has been alive for certain frames, or other suitable temporal status. Other states can include, additionally or alternatively, whether the tracker is considered as lost when it does not associate with any foreground blob in the current frame, whether the tracker is considered as a dead tracker if it fails to associate with any blobs for a certain number of consecutive frames (e.g., 2 or more), or other suitable tracker states.

One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, there may be other status information needed for updating the tracker, which may require a state machine for object tracking. Given the information of the associated blob(s) and the tracker's own status history table, the status also needs to be updated. The state machine collects all the necessary information and updates the status accordingly. Various statuses can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other object of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration has passed, the tracker may be promoted to be a normal tracker and output as an identified tracker-blob pair. A tracker-blob pair is output at the system level as an event (e.g., presented as a tracked object on a display, output as an alert, or other suitable event) when the tracker is promoted to be a normal tracker. A tracker that is not promoted as a normal tracker can be removed (or killed), after which the track can be considered as dead.

As described above, blobs can be used for object tracking using blob trackers. A new tracker starts to be associated with a blob in one frame, and may be connected with possibly moving blobs across one or more subsequent frames. The new tracker is hidden and not output for actual tracking of the blob or object until the new tracker is promoted to a normal status. For example, a hidden tracker is one that is not shown on a display as tracking a displayed object. When a new tracker has been continuously associated with blobs and a duration has passed, the tracker can be promoted or converted to be a normal tracker. When a blob tracker is converted or promoted to a normal tracker, the blob or object with which the blob tracker is associated is converted from a potential hidden blob or object to a normal blob or object. The normal tracker and blob are output as an identified tracker-blob pair to the video analytics system so that the system can begin tracking the blob or object, in addition to other system level events. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by a rule interpreter). For example, one example of a system level event is that, once tracking begins, the tracker is shown on a display as tracking the object for which it is associated.

In some cases, a potential blob (an object or a portion of an object) is kept in a hidden tracker until the blob and tracker are identified as a normal blob and tracker after some time. The amount of time a blob tracker is kept hidden or new can be measured using a threshold duration (denoted below as T_{new} or T_{split-new}), after which the blob tracker (and its associated blob) is converted to a normal status. This type of tracker-blob conversion (referred to herein as a normal tracking process) can work well for some tracking situations, such as certain outdoor surveillance situations. However, such a tracker-blob conversion technique can prevent detection of certain blobs in situations when the blob has an unusual size (e.g., in some indoor surveillance scenarios, in some outdoor surveillance scenarios, or other scenarios). In one example, if a person moves across a room quickly and is close to the camera, the video analytics system may miss the person. For instance, the person may not be tracked because the system may still be in the process of confirming if the blob associated with the person is a valid blob (e.g., if the threshold duration is met) when the person disappears from the field of view. In such an example, the blob and its associated tracker will not be converted to normal status while the person is in the scene. In another example, a big blob can split from another blob that it is merged with, in which case it may take a while for the big blob and its associated tracker to be identified as a normal blob and tracker that was split from merged blob group. In such an example, the object is not tracked due to the threshold duration not being met. In yet another example, a huge object in the field of view can be mapped to a small blob when segmentation errors cause a blob to be broken into multiple blobs. For example, a big blob can be broken into multiple smaller blobs due to segmentation errors (e.g., when a portion of an object blends in with the background, causing the object to be segmented into multiple blobs). In such an example, the original big object (before a segmentation error) will be associated one of the small blobs. In other examples, the tracker-blob conversion using the threshold duration may not work when a huge object enter the field of view and does not move very much, when a part of the room has changing lighting conditions (e.g., due to a curtain, a door opening or closing, or other effect), and/or when a small object in the field of view is mapped to a huge blob due to a noisy background that causes foreground detection to fail and huge blobs to be extracted from the field of view. Such problems can cause object tracking inconsistencies.

In order to reduce missing or delayed detection of objects, content-adaptive tracking systems and methods are provided for identifying and tracking blobs more quickly and for discarding abnormal false positives in time. For example, size-based blob (or object) tracking is provided for tracking blobs generated for a video frame in a content-adaptive manner based on a size of the blob, based on sizes of a blob tracker used to track one or more blobs in one or more previous frames, based on an amount of time the blob tracker has been active, or any combination thereof. In some examples, a huge size object conversion technique can be used to convert a huge object and its associated tracker to a normal object and tracker more quickly compared with other objects. In another example, a size and motion based split-new object promotion technique can be used to convert a large object (and associated tracker) that is split from an object group earlier than the normal object split procedure. Size ratio conditional matching systems and methods are also provided for rejecting mapping or association between a tracker and a blob that have a size ratio indicating abnormal blob size changes (e.g., due to segmentation or other cause of size change).

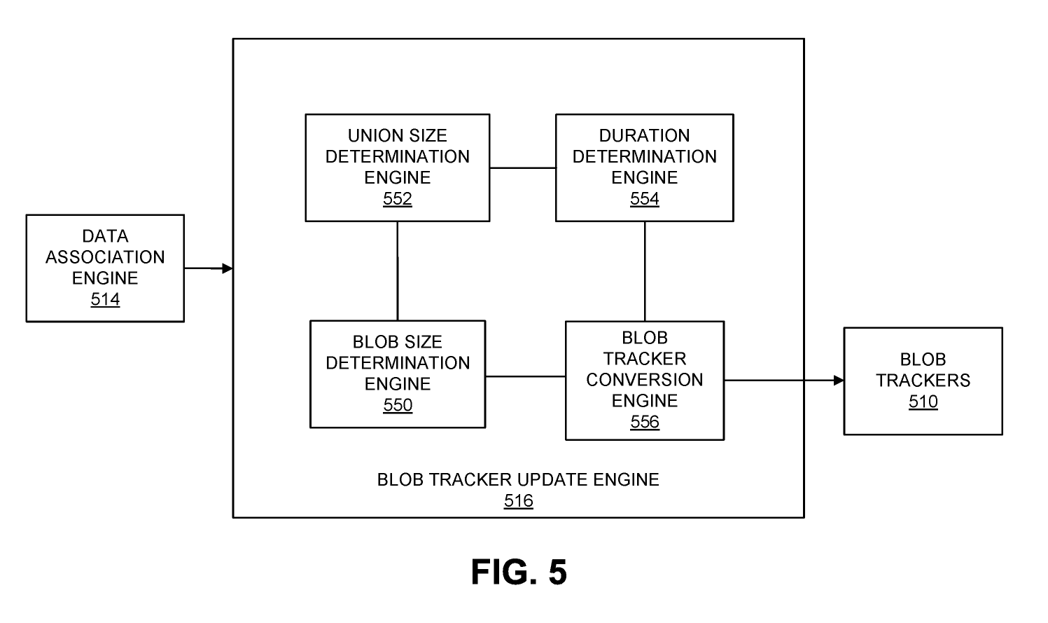

FIG. 5 is a block diagram illustrating an example of a blob tracker update engine 516 that can implement content-adaptive tracking. The blob tracker update engine 516 includes a blob size determination engine 550, a union size determination engine 552, a duration determination engine 554, and a blob tracker conversion engine 556. Using a normal tracking process, the system waits a threshold duration T_{new} before verifying the hidden new tracker as a normal tracker. The threshold duration can be a number of frames (e.g., at least N frames) or an amount of time. In one illustrative example, typical trackers can be hidden for 30 frames before being converted to a normal tracker.

In certain cases, however, new trackers and their associated objects need to be identified as normal earlier than the threshold duration. This may be the case for huge objects or big objects, which may need to be outputted to the system for tracking as soon as possible. The blob tracker update engine 516 can perform content-adaptive blob (or object) tracking based on one or more of a size of the blob, sizes of a blob tracker used to track one or more blobs in one or more previous frames, an amount of time the blob tracker has been active, or any combination thereof. Based on one or more of these factors, a new or split-new blob tracker and the blob the new blob tracker is associated with can be converted from new or split-new to normal immediately or more quickly than the threshold duration. As described in further detail below, a split-new tracker is a tracker that is split from an existing tracker.

The blob tracker update engine 516 can perform various conversion techniques to determine when to convert a tracker to a normal tracker. In some examples, the type of conversion technique performed for a blob tracker can be based on the type of the blob tracker. For example, a huge blob (or object) conversion technique can be performed for new trackers. In various implementations, the huge blob conversion technique can also be performed for other trackers, such as split-new trackers. The huge blob conversion technique can convert a new tracker and its associated blob to a normal blob tracker-blob pair based on a size of the blob, sizes of the blob tracker used to track one or more blobs in one or more previous frames, an amount of time the blob tracker has been active. As used herein, a huge blob is a blob with a size greater than a huge blob size threshold. The huge blob size threshold can be based on the size of the frame or image. For example, the huge blob size threshold can be set as a fraction of the entire frame size or image size, such as half of the frame size (½×frame size), a quarter of the frame size (¼×frame size), or other suitable fractional amount. Accordingly, a blob that takes up the fractional amount of the frame according to the huge blob size threshold (e.g., half the frame, a quarter of the frame, or other suitable amount) is considered huge.

Another conversion technique includes a big blob (or object) conversion technique. The big blob conversion technique can be performed for split-new trackers. In various implementations, the big blob conversion technique can also be performed for other trackers, such as new trackers. The big blob conversion technique can convert a split-new tracker and its associated blob to a normal blob tracker-blob pair based on a size of the blob and sizes of the blob tracker used to track one or more blobs in one or more previous frames. As used herein, a big blob is a blob with a size greater than a big blob size threshold, which is smaller than the huge blob size threshold. The big blob size threshold can also be based on the size of the frame or image. For example, the big blob size threshold can be set as a fraction of the entire frame size or image size, such as a fifth of the frame size (⅕×frame size), a sixth of the frame size (⅙×frame size), a tenth of the frame size ( 1/10×frame size), or other suitable fractional amount. A blob that takes up the fractional amount of the frame according to the big blob size threshold (e.g., a fifth of the frame, a sixth of the frame, a tenth of the frame, or other suitable amount) is considered big.

Another conversion technique includes a size-based blob (or object) conversion technique that can be performed on any blob tracker, including a new blob tracker, a split-new blob tracker, or other blob tracker. The size-based blob (or object) conversion technique can convert a tracker and its associated blob to a normal blob tracker-blob pair based on a size of the blob, as compared to a size threshold. The size threshold can include the huge blob size threshold, the big blob size threshold, or a different size threshold that is larger or smaller than the huge blob size threshold and the big blob size threshold.

In some examples, an abnormal size change of blobs can be detected and used to prevent or allow a blob tracker from being associated or matched with a blob. In certain environments (e.g., an indoor surveillance environment, an outdoor surveillance environment, or other suitable environment), it is not unusual that segmentation errors cause mismatching between trackers and blobs, for example, when larger objects are involved. For example, segmentation errors can occur when an object has a feature that blends in with the background, causing the object to be segmented into multiple blobs. In one example, a person in a scene captured by a current frame can be wearing a black belt and can walk in front of a black background object. For the current frame, the belt can be considered as background in the foreground mask generated for the current frame. Segmentation error of the person thus occurs, with the upper portion of the person being segmented from the lower portion of the person due to the belt being considered as background for the current frame. A tracker that was previously associated with the entire object (the person) may be associated with or matched with one of the segmented blobs (either the blob for the upper portion of the person or the blob for the lower portion of the person), leading to mismatching between the tracker and blob. In order to reduce the effect of mismatch due to segmentation and similar errors, the abnormal size change detection technique can identify abnormal size changes and can reject unlikely matching if size change is abnormal.

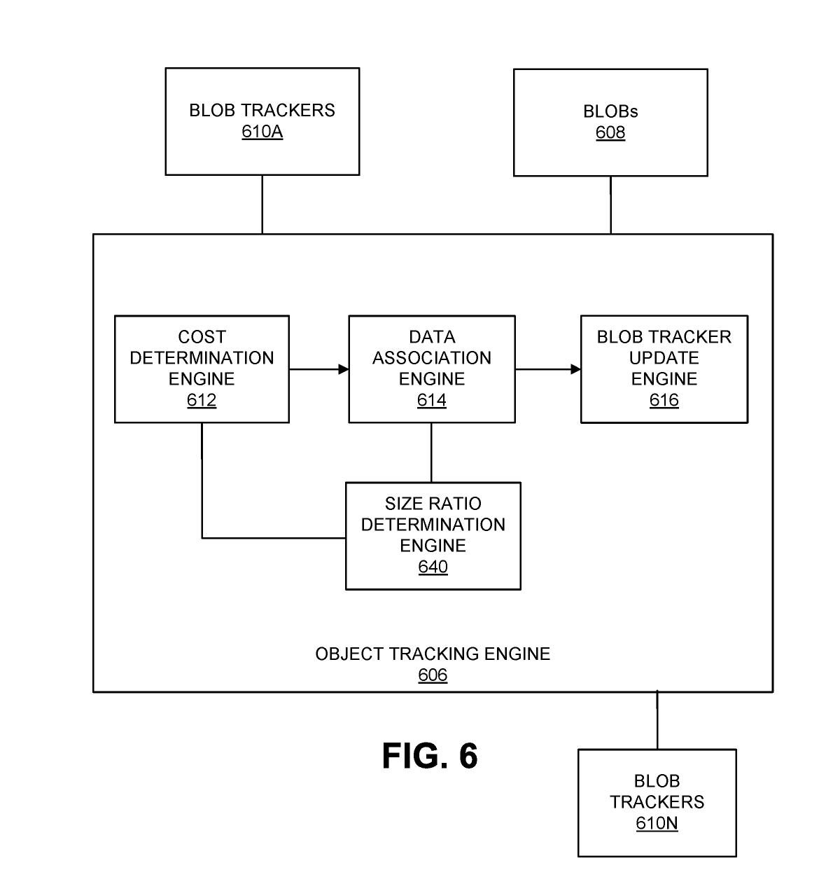

FIG. 6 is a block diagram illustrating an example of an object tracking engine 606 that can perform an abnormal size change technique to detect abnormal size changes. The object tracking engine 606 includes a cost determination engine 612, a data association engine 614, a blob tracker update engine 616, and a size ratio determination engine 640. The cost determination engine 612 and data association engine 614 are similar to and can perform similar operations as the cost determination engine 412 and data association engine 414 described above with respect to FIG. 4. The blob tracker update engine 616 is similar to and can perform similar operations as the blob tracker update engine 516 described herein with respect to FIG. 5.

The size ratio determination engine 640 of FIG. 6 can use the blob trackers 610A and blobs 608 to determine a size ratio R_{AB}. The size ratio includes a ratio between the size of an intersecting region and the size of a union region (denoted as

$${R}_{AB} = \frac{{Size}_{A ⋂ B}}{{Size}_{A ⋃ B}} )$$

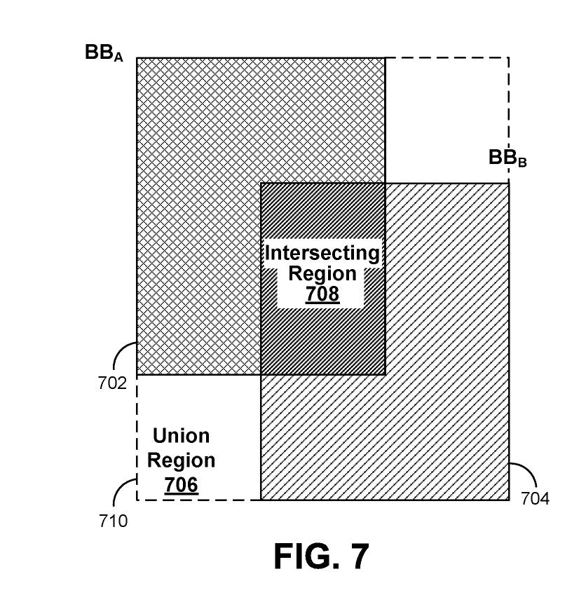

of a current blob tracker and an associated blob in a current frame. The term A is used here to denote the bounding box of the current tracker in the current frame (denoted as BB_{A} in FIG. 7) and the term B is used here to denote the bounding box of a blob detected in the current frame that is associated with the current tracker (denoted as BB_{B} in FIG. 7). As previously described, the bounding box A of the current tracker can be the bounding box of the blob detected in the previous frame that was associated with the tracker. The intersection of A and B is denoted as A∩B and the union of A and B is denoted as A∪B.

FIG. 7 shows an example of an intersection and union of two bounding boxes, including bounding box BB_{A} 702 of the current tracker and bounding box BB_{B} 704 of the blob. The intersecting region 708 includes the overlapped region between the bounding box BB_{A} 702 associated with the blob tracker and the bounding box BB_{B} 704 associated with the blob.

The union region 706 includes the union of bounding box BB_{A} 702 and bounding box BB_{B} 704. The union of bounding box BB_{A} 702 and bounding box BB_{B} 704 is defined as the far corners of the two bounding boxes, and can be used to create a new bounding box 710 (shown as dotted line). More specifically, by representing each bounding box with (x, y, w, h), where (x, y) is the upper-left coordinate of a bounding box, w and h are the width and height of the bounding box, respectively, the union of the bounding boxes would be represented as follows:

Union(BB₁, BB₂)=(min(x₁, x₂), min(y₁, y₂), (max(x₁+w₁−1,x₂+w₂−1)−min(x₁, x₂)), (max(y₁+h₁−1,y₂+h₂−1)−min(y₁,y₂)))

After the intersecting region (e.g., intersecting region 708) and union region (e.g., union region 706) are detected, the size ratio determination engine 640 of FIG. 6 can determine the size of each region, and can then determine the size ratio R_{AB}. The size can be determined as the area of the region, such as the width times the height of the region. As noted above, the size ratio includes a ratio between the size of the intersecting region and the size of the union region, denoted as

$${R}_{AB} = \frac{{Size}_{A ⋂ B}}{{Size}_{A ⋃ B}} .$$

The size ratio determination engine 640 can then compare the value of R_{AB} to a size change threshold T_{R} to determine whether there is an abnormal size ratio between the tracker and the blob and thus whether an abnormal size change has occurred between frames. For example, if R_{AB} is less than the size change threshold T_{R} (denoted as R_{AB}<T_{R}), there is a probability that the match (or association) between the blob tracker bounding box A and the blob bounding box B is not a good match, since the size of the tracker and the blob has changed too much across frames. As noted above, the tracker bounding box A can be the bounding box of the blob detected in the previous frame that was associated with the tracker, and can thus be used to compare against the size of the blob bounding box B to determine a change in size of the blob. R_{AB} should be consistent and large in general for a real object, indicating that the object has a consistent size across two or more frames. A small size ratio can be due to segmentation or some other cause. For example, a blob corresponding to an entire person in a first frame can have a smaller size in a second frame because the blob in the second frame corresponds to only the upper portion of the person due to segmentation of the person (e.g., due to the person having a belt that blends in with the background, as described in the example above).

In some examples, should it be determined that that the size ratio R is less than the size change threshold T_{R}(R_{AB}<T_{R}), the size ratio determination engine 640 can cause the cost determination engine 612 to assign (or re-assign) a cost (e.g., the distance) between the tracker and the blob as a maximum cost value that includes a large value. The large cost value will prevent the tracker from being associated or matched with the blob by the data association engine 614, and in some instances, effectively remove the association between the blob tracker and the blob. In some examples, if it is determined that the size ratio R is less than the size change threshold T_{R}(R_{AB}<T_{R}), the size ratio determination engine 640 can cause the data association engine 614 to discard the match or association between the tracker and the blob. In some illustrative examples, T_{R} can be set to 0.1, 0.15, 0.2, or some other suitable value. In some cases, if the size ratio R_{AB} is less than or equal to the size change threshold T_{R}(R_{AB}≦T_{R}), the cost determination engine 612 can assign the cost (e.g., the distance) between the tracker and the blob as the maximum cost value.

In the event the size ratio determination engine 640 determines that the size ratio R is greater than the size change threshold T_{R}(R_{AB}>T_{R}), the cost determination engine 612 can maintain or assign a determined physical distance between the blob tracker and the blob as a cost for the tracker-blob pair. In some cases, if the size ratio R is greater than or equal to the size change threshold T_{R}(R_{AB}>T_{R}), the cost determination engine 612 can maintain or assign the physical distance as the cost for the tracker-blob pair. In some examples, a previously assigned cost can be maintained. In some examples, the physical distance can be assigned as the cost between the blob tracker with bounding box A and the blob with bounding box B. Using a cost matrix (not shown), the data association engine 614 can determine whether to associate or match the blob tracker with the blob based on the cost (as previously described).

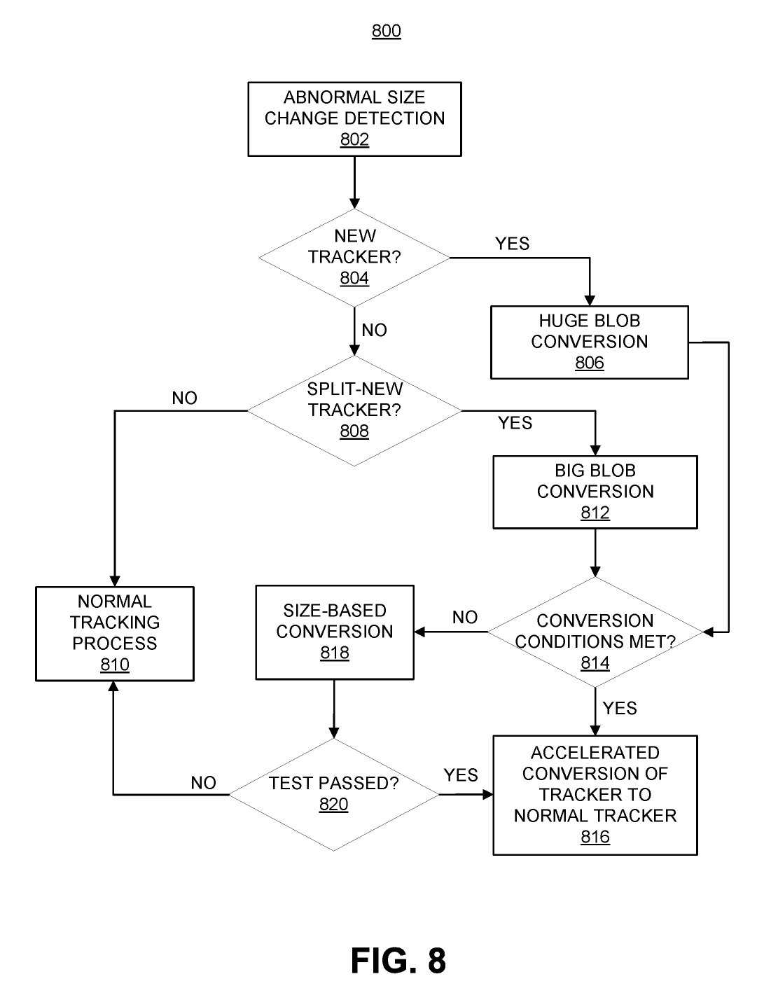

The various conversion techniques discussed above can be used independently or in combination with one another. In addition, the abnormal size change technique can be used independently or in combination with one or more of the conversion techniques. FIG. 8 illustrates an example of a process 800 of determining whether to accelerate conversion of a tracker and an associated blob to normal status from new (hidden) status. The process 800 can be performed by the blob tracker update engine 516 and/or the cost determination engine 612. While the process 800 is shown as performing abnormal size change detection, a huge blob conversion, a big blob conversion, and a size-based conversion, one or more of the abnormal size change detection and/or the conversion techniques can be omitted from the process 800 in some implementations.

At 802, the process 800 includes performing abnormal size change detection for blobs in a frame, as described above with respect to FIG. 6 and FIG. 7. For example, the process 800 of FIG. 8 can begin by measuring the tracker-blob mappings or associations to see if the size ratios of the blob-tracker pairs is normal (e.g., greater than a threshold T_{R}). If a size ratio for an associated blob and tracker is abnormal, the mapping can be discarded (e.g., by assigning a high cost value).

At 804, the process 800 can determine whether a blob tracker is a new tracker. A new tracker includes a tracker that is currently hidden and that has not been converted to a normal tracker. If the blob tracker is a new tracker, huge blob conversion is performed at 806. The huge blob conversion technique can include a size and object history-based method to convert a new tracker to a normal tracker quickly if some conditions are satisfied. If the conditions are not satisfied, the conversion may be performed using the big blob conversion technique, the size-based conversion technique, or the normal tracking process (using the threshold duration).

The size of the bounding box in the current frame for the new tracker can be checked first to see if the object is big enoughto trigger performance of the huge blob conversion technique. For example, if the size of the bounding box is larger than a threshold (and, in some cases, equal to the threshold), the huge blob conversion technique can continue. If the size of the bounding box is smaller than the threshold (and, in some cases, equal to the threshold), the huge blob conversion technique can be skipped. The threshold can be the same as the threshold T₂ described below, or can be a different threshold that is a fraction of the frame size or image size (e.g., a fifth of the frame size, a sixth of the frame size, a tenth of the frame size, or other suitable fractional amount). A size of a blob bounding box and a blob tracker bounding box can be defined using one or more techniques. In one example, the size of a bounding box for a blob or tracker can be determined by calculating the area of the bounding box (e.g., a width of the bounding box multiplied by a height of the bounding box). In some examples, the size of a blob can be defined as the number of foreground pixels in the blob, in which case the size of a blob can be determined by counting the number of pixels that make up the blob.

To perform the huge blob conversion technique, the blob tracker update engine 516 (e.g., the union size determination engine 552) can determine a location history of the new tracker. The location history can include one or more locations of one or more bounding boxes associated with the blob tracker in one or more previous video frames. For example, at a specific time T, all of the bounding boxes Bᵢ (i=1, . . . , T) of the previously detected blobs associated with the new tracker make up the location history of the tracker. The location history can be denoted as L_{T}={B_{T-1}, . . . , B₁}.

The blob tracker update engine 516 (e.g., the union size determination engine 552) can also determine a union of the location history of the tracker, which is the union of the one or more bounding boxes at the one or more locations in the one or more previous video frames. For example, the union of the location history of the tracker can be the union of all the bounding boxes in the location history of the tracker. The union of the location history of the new tracker is defined as U_{T}=∪ₜ₌₁^{T}Bₜ. The union size determination engine 552 can determine the size of the union of the location history U_{T} (denoted sizeUnion). For example, the sizeUnion can be determined as described above with respect to FIG. 7, and can include the far corners of the outside bounding boxes of the bounding boxes in the location history. The blob size determination engine 550 can determine the size of the current blob mapped to the new tracker (denoted sizeCurr). For example, the size of the blob can include the area of the bounding box of the blob or the number of pixels making up the blob.

The duration determination engine 554 can determine a duration for which the new tracker has been active (e.g., the duration from the time the tracker is generated to the current frame). The duration can be measured by a number of frames, by an amount of time, or other suitable duration measurement. In some examples, the duration can be determined based on the history or motion model of the new tracker.

The blob tracker conversion engine 556 can compare the sizeUnion, the sizeCurr, and the new tracker duration to certain thresholds to determine whether to convert the new tracker to a normal tracker. If these huge blob conversion threshold conditions are determined to be met at 814 of FIG. 8, the process 800 performs accelerated conversion of the tracker to a normal tracker at 816. For example, if sizeUnion>T₁, sizeCurr>T₂ (with T₁>T₂), and the current tracker has survived for an accelerated threshold duration T_{accel}, the new tracker will be promoted to be normal tracker (without any further duration requirement). The accelerated threshold duration T_{accel} can be a duration that is shorter than a threshold duration T_{new}.

Here, T_{new} is a constant (referred to as the threshold duration) that defines the duration of a new tracker to be promoted to be normal tracker in the normal tracking process. The accelerated threshold duration T_{accel} can include, for example, a quarter of the duration required by the threshold duration T_{new} (denoted as T_{accel}=T_{new}/4). The threshold duration T_{new} and the accelerated threshold duration T_{accel} can be a number of frames (e.g., at least N frames) or an amount of time. For example, as described above, traditional tracking techniques may require a hidden new tracker to wait the threshold duration (e.g., 20 frames, 30 frames, 32 frames, or other suitable number of frames) before the new tracker is verified as a normal tracker. In one illustrative example, the threshold duration (T_{new}) can be 30 frames and the accelerated threshold duration (e.g., T_{new}/4) can be 8 frames (7.5 rounded up to 8). The term T₁ can be referred to as a union size threshold, and can be set to a fraction of the frame or image size. For example, the union size threshold (T₁) can be set to a very large value, such as half of the frame size or image size (½×frame size), a quarter of the frame size (¼×frame size), or some other suitable fractional amount. The term T₂ can be referred to as a blob size threshold, and can also be set to a fraction of the frame or image size. For example, the blob size threshold (T₂) can be set to a fifth of the frame size (⅕×frame size), a sixth of the frame size (⅙×frame size), a tenth of the frame size ( 1/10×frame size), or other suitable fractional amount. Otherwise, if it is determined that the huge blob conversion conditions are not met at 814, the new tracker can be converted according to the size-based conversion at 818 or the normal tracking process at 810.

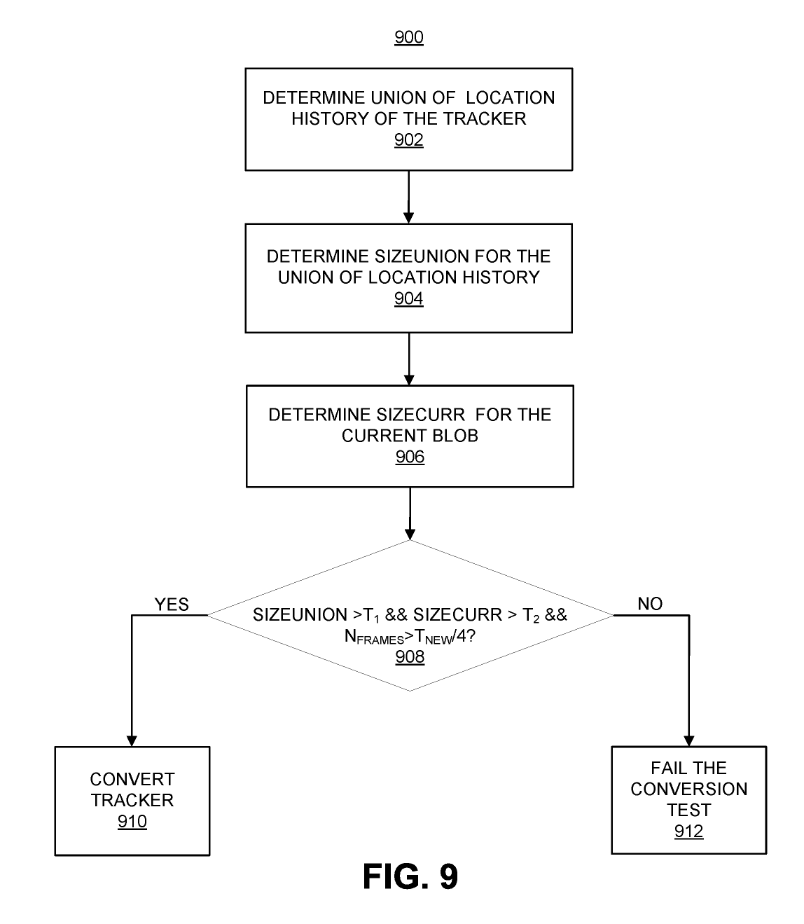

Using huge blob conversion, a new tracker that tracks a huge blob (larger than the blob size threshold T₂) can be converted to be a normal tracker much faster than the other blobs that are smaller than the blob size threshold T₂. Further details of the huge blob conversion technique are described below with respect to FIG. 9.

Returning to FIG. 8, if the blob tracker is determined not to be a new tracker at 804, the process 800 determines if the tracker is a split-new tracker at 808. A tracker that is split from an existing tracker is referred to as a split-new tracker. In some examples, a split-new tracker can result from the mapping (or association) of multiple blobs to one active tracker. One active tracker can only be mapped to one blob. All the other blobs (the blobs remaining from the multiple blobs that are not mapped to the tracker) cannot be mapped to any existing trackers. In such examples, new trackers will be created for the other blobs, and these new trackers are assigned the state “split-new.” Such a split-new tracker can be referred to as the child tracker of the original tracker its associated blob is mapped to. The corresponding original tracker can be referred to as the parent tracker of the child tracker.

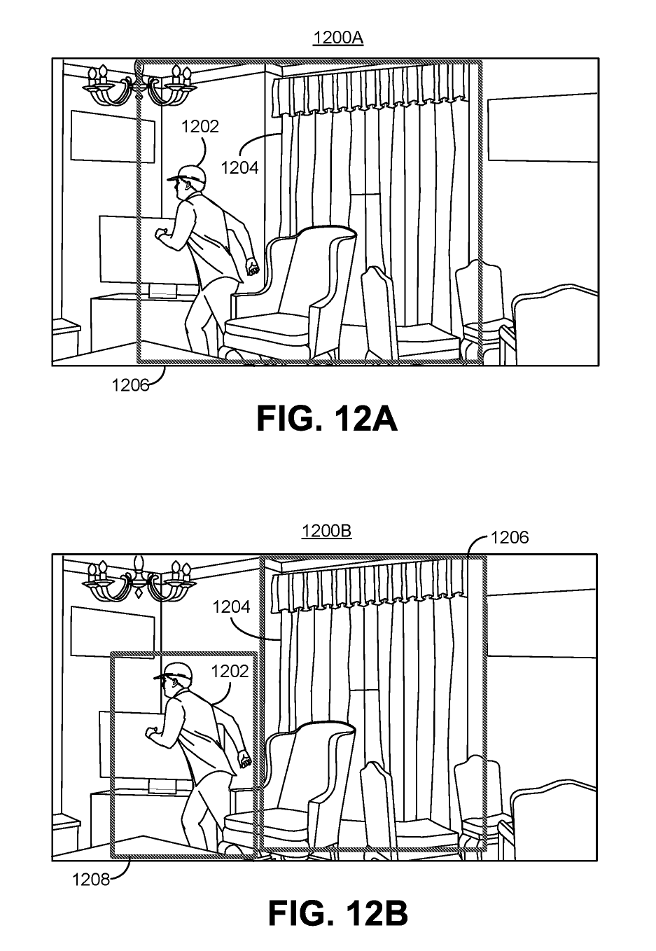

In some examples, a split-new tracker can also result from a merge-contained tracker (shown in FIG. 12A and FIG. 12B, described further below). A merge-contained tracker is a tracker that was a normal tracker but was merged with another tracker (when two blobs for the respective trackers are merged) and thus became hidden and carried by the container tracker. A merge-contained tracker can be split from the container tracker if the container tracker is active and the container tracker has a mapped blob in the current frame. For example, a blob can associate with a merge-contained tracker when the distance between the blob and tracker is less than a threshold. In typical tracking methods, a merge-contained tracker needs to wait at least N frames to be verified as a confident split and to be considered a split-new tracker, which is similar to how a new tracker turns into a normal tracker. However, for certain cases (e.g., indoor surveillance cases, some outdoor surveillance cases, or other situation), it is desirable to catch the split object and output the split-new tracker as soon as possible.

If the blob tracker is determined to be a split-new tracker at 808 of FIG. 8, big blob conversion is performed at 812. The big blob conversion technique can include a size and object history based conversion to promote a split-new tracker to a normal tracker quickly if some conditions are satisfied. If the conditions are not satisfied, the conversion may be performed using the size-based conversion technique or the normal tracking process (using the threshold duration).

To perform the big blob conversion technique, the blob tracker update engine 516 (e.g., the union size determination engine 552) can determine a location history of the split-new tracker. Similar to that described above, at a specific time T, all of the bounding boxes Bᵢ(i=1, . . . , T) of the previously detected blobs associated with the split-new tracker make up the location history of the split-new tracker.

The blob tracker update engine 516 (e.g., the union size determination engine 552) can also determine a union of the location history of the split-new tracker, which is the union of the one or more bounding boxes at the one or more locations. For example, the union of the location history of the split-new tracker can be the union of all the bounding boxes in the location history of the split-new tracker. The union of the location history of the split-new tracker is defined as U_{T}=∪ₜ₌₁^{T}Bₜ. The union size determination engine 552 can determine the size of the union of the location history U_{T} (denoted sizeUnion) of the split-new tracker. For example, the sizeUnion can be determined as described above with respect to FIG. 7, and can include the far corners of the outside bounding boxes of the bounding boxes in the location history. The blob size determination engine 550 can determine the size of the current blob mapped to the split-new tracker (denoted sizeCurr). For example, the size of the blob can include the area of the bounding box of the blob or the number of pixels in the blob.

The blob tracker conversion engine 556 can compare the sizeUnion and the sizeCurr of the split-new tracker to certain thresholds to determine whether to convert the split-new tracker to a normal tracker. If these big blob conversion threshold conditions are determined to be met at 814 of FIG. 8, the process 800 performs accelerated conversion of the tracker to a normal tracker at 816. For example, if sizeUnion>T₁′ and sizeCurr>T₂′(T₁′>T₂′), the split-new tracker will be promoted to be a normal tracker (without any further duration requirement). The term T₁′ is a union size threshold that is smaller than the union size threshold T₁ used in the huge blob conversion. In some cases, the union size threshold T₁′ can be referred to as a big blob union size threshold and the union size threshold T₁ can be referred to as a huge blob union size threshold. In one illustrative example, the huge blob union size threshold T₁ can be set to a quarter of the frame size, and the big object union size threshold T₁′ can be set to ⅙ of the frame size. The term T₂′ is a blob size threshold that is smaller than the blob size threshold T₂. In some cases, the blob size threshold T₂′ can be referred to as a big blob size threshold and the blob size threshold T₂ can be referred to as a huge blob size threshold. In one illustrative example, the huge blob size threshold T₂ can be set to a tenth of the frame size, and the big object size threshold T₂′ can be set to a 1/15 of the frame size.

In some examples, even if both of the conditions sizeUnion>T₁′ and sizeCurr>T₂′ are not satisfied, some parameters of the system can be adjusted according to the current object size in order to accelerate conversion at 816 at a slower rate. For example, if sizeCurr>T₂′, the duration or waiting period for conversion of the split-new tracker to a normal tracker can be updated to a fraction (e.g., half, a third, a quarter, or other suitable amount) of a typical threshold duration T_{split-new} used for split-new trackers, allowing the split-new tracker to be converted to a normal tracker faster (e.g., in half the time, a quarter of the time, or the like) than trackers associated with smaller blobs. In some examples, the threshold duration T_{split-new} used for split-new trackers can be the same as the threshold duration T_{new} used for new trackers (e.g., 20 frames, 30 frames, 32 frames, or other suitable number of frames). In some examples, the threshold duration T_{split-new} can be a shorter duration than the threshold duration T_{new} used for new trackers.

In some examples, if the sizeCurr>T₂′ condition is not met, the duration or waiting period can be further adjusted in order to accelerate conversion at 816 at an even slower rate. For example, if sizeCurr>T₃(T₃<T₂′), the duration or wait period for converting the split-new tracker to a normal tracker can be updated to an even larger fraction (e.g., half, ¾, ⅘, or other suitable amount) of the threshold duration T_{split-new}. However, if sizeCurr<T₄(T₄<<T₁), the big blob conversion test is failed since the object size is smaller than what is needed for the test. For example, if the big blob conversion conditions are determined to not be met at 814, the split-new tracker can be converted according to the size-based conversion at 818 or the normal tracking process at 810. The term T₃ is a blob size threshold that is smaller than the blob size threshold T₂′. In some cases, the blob size threshold T₃ can be referred to as a secondary big blob size threshold. In one illustrative example, the big blob size threshold T₂′ can be set to a 1/15 of the frame size, and the secondary big blob size threshold T₃ can be set to 1/20 of the frame size. The term T₄ is a blob size threshold that is much smaller than the blob size threshold T₁, and can be referred to as a minimum blob size threshold T₄. In one illustrative example, the minimum blob size threshold T₄ can be a small fractional percentage of the frame or image size, such as 1/25, 1/30, 1/35, 1/40, or other small percentage.

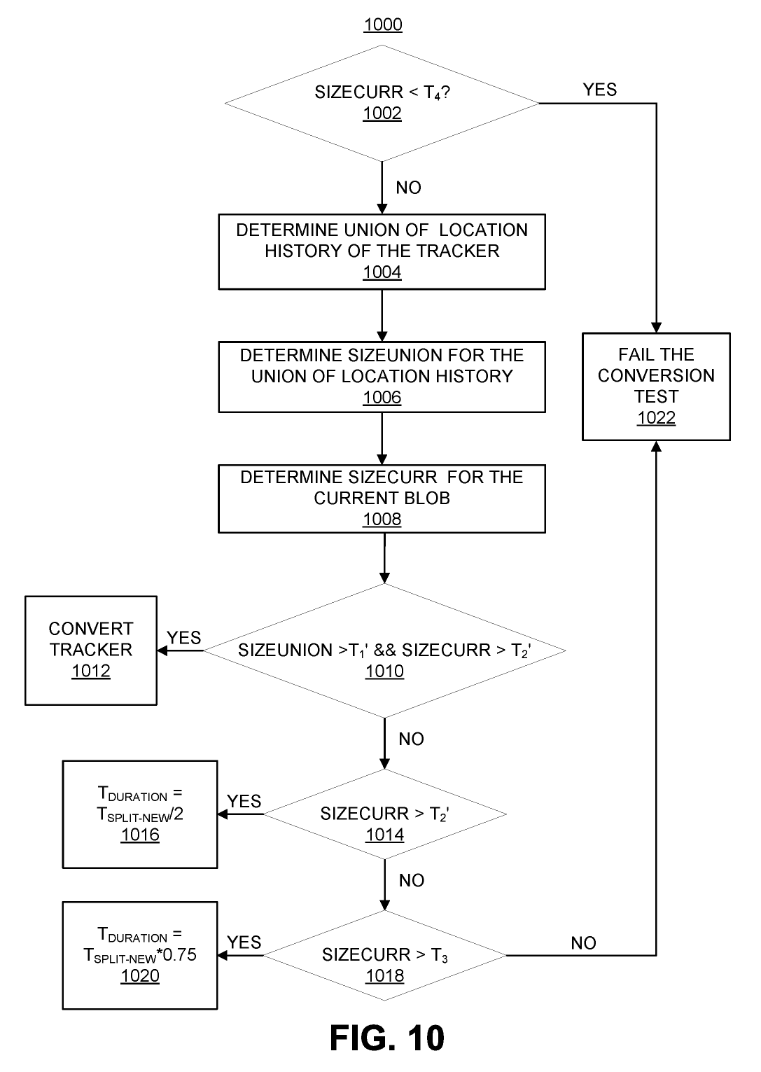

Using big blob conversion, a split-new tracker that tracks a big blob (a blob larger than the big blob size thresholds T₂′ or T₃) can be converted to a normal tracker faster than other blobs that are smaller than the blob size thresholds T₂′ or T₃. For example, a big object can be quickly promoted to be a normal tracker from a split-new tracker if its associated object (or blob) moves fast in the scene. Further details of the big blob conversion technique are described below with respect to FIG. 10.

In the event it is determined at 808 of FIG. 8 that the blob tracker is not a split-new tracker, the process 800 can perform the normal tracking process at 810 using only a threshold duration (e.g., T_{new},T_{split-new}, or other threshold duration). In such cases, the blob tracker is not a new tracker or a split-new tracker. For example, other types of trackers include lost trackers and merge-contained trackers. A lost tracker is a tracker that has no matched blob in the field of view (e.g., in a current frame). As previously described, a merge-contained tracker is a tracker that is merged to another tracker and has no independent blob associated with it. Other types of trackers may also be maintained by the video analytics system. Using the normal tracking process at 810, the process 800 can wait the threshold duration T_{new} or T_{split-new} before converting a tracker to a normal tracker. As previously described, the threshold durations T_{new} and T_{split-new} can be a number of frames (e.g., at least N frames) or an amount of time. In one illustrative example, the threshold duration T_{new} can include 30 frames and the threshold duration T_{split-new} can be 20 frames. In another illustrative example, both the threshold durations T_{new} and T_{split-new} can include 30 frames.

At 818, the process 800 can perform size-based conversion in the event none of the huge object conversion or big object conversion conditions are determined to be met at 814 for a new tracker or a split-new tracker. For certain situations (e.g., indoor surveillance cases, some outdoor surveillance cases, or other situation), it can be perplexing if a large object appears in the field of view and it cannot be tracked immediately. The traditional object tracker that uses the threshold duration T_{new} or T_{split-new} delays the object to be outputted until it tracks the object for at least N frames with consistency check. However, such a long duration can dramatically affect the subjective evaluation results (e.g., it may cause the tester to think the object tracking is responding too slowly or that it is ineffective). In order to overcome this issue, the size-based conversion can convert a new or split-new tracker to a normal tracker for a current frame immediately when the new or split-new tracker has tracked an object for a modified threshold duration T_{mod} and if the size of the tracked object in the current frame is greater than a threshold T₅.

The modified threshold duration T_{mod} for performing the size-based conversion is a shorter duration than the threshold durations T_{new} and T_{split-new}. In some cases, the modified threshold duration T_{mod} can be a longer duration than the accelerated threshold duration T_{accel} for the huge blob conversion. For example, as described above, traditional tracking techniques may require a hidden new tracker to wait the threshold duration T_{new} (e.g., 20 frames, 30 frames, 32 frames, or other suitable number of frames) before it is verified as a normal tracker, and the accelerated threshold duration T_{accel} can be a shortened threshold duration (e.g., T_{new}/4). The modified threshold duration T_{mod} can be a duration between the threshold duration T_{new} and the accelerated threshold duration T_{accel}. In one illustrative example, the threshold duration T_{new} can be 30 frames, the accelerated threshold duration T_{accel} (e.g., T_{new}/4) can be 8 frames (7.5 rounded up to 8), and the modified threshold duration T_{mod} (e.g., T_{new}/2) can be 15 frames.

The threshold T₅ can be referred to as a size threshold and can include a big portion of the frame or field of view. In some cases, the size threshold T₅ is smaller than any of the other size thresholds T₂, T₂′, and T₃. For instance, T₅ can be set to a tenth of the frame size (imageSize/10) or any other suitable value. If the size-based conversion threshold conditions are determined to be met at 820, the process 800 performs accelerated conversion of the tracker to a normal tracker at 816. For example, the tracker can immediately be converted to normal without any further duration required. Otherwise, if the size-based conversion condition is not met, the normal tracking process can be performed on the new or split-new tracker at 810.

FIG. 9 illustrates an example of a process 900 of performing a huge blob conversion technique. As described previously, huge blob conversion includes a size and object history based method to promote a new tracker to a normal tracker quickly. At 902, the process 900 determines a union of the location history of the new tracker. The union of the location history of the new tracker is the union of all the bounding boxes in the location history of the new tracker. The union of the location history of the new tracker is defined as U_{T}=∪ₜ₌₁^{T}Bₜ.

At 904, the process 900 determines a size of the union of the location history of the new tracker. The size of U_{T} is called sizeUnion. At 906, the process 900 determines a size of the current blob that is mapped to (or associated with) the new tracker. The size of the current blob mapped to the new tracker is called sizeCurr.

At 908, the process 900 determines if the huge object conversion conditions are met. For example, at 908, it is determined if sizeUnion>T₁, sizeCurr>T₂(T₁>T₂), and the current new tracker has survived T_{new}/4 frames. If the conditions are met, the new tracker is converted to be a normal tracker at 910. If any one of the conditions are not met, the huge object conversion test fails at 912.

FIG. 10 illustrates an example of a process 1000 of performing a big blob conversion technique. As described previously, big blob conversion includes a size and object history based split-new object promotion method to promote a split-new tracker to a normal tracker earlier than the normal tracker conversion procedure. In some examples, the split-new tracker can include a tracker that was a merge-contained tracker merged with an active container tracker that has a mapped blob in the current frame. A merge-contained tracker is a tracker that is hidden and associated with a container tracker. In some examples, the split-new tracker can include a tracker that is created for a blob that is mapped to an active tracker, but the active tracker is not mapped to the blob in the current frame (e.g., due to a mapping of multiple blobs to one active tracker).

At 1002, the process 1000 includes determining if a size of a current blob that is associated with a split-new tracker is less than a threshold size T₄. For example, if sizeCurr<T₄(T₄<<T₁), the big object conversion test fails at 1022 since the blob size is smaller than what is needed for the test.

At 1004, the process 1000 determines a union of the location history of the split-new tracker. All the bounding boxes of the previous detected blobs of the split-new tracker are called the location history of the tracker. The union of the location history of the split-new tracker is the union of all the bounding boxes in the location history of the split-new tracker. The union of the location history of the tracker is defined as U_{T}=∪ₜ₌₁^{T}Bₜ.

At 1006, the process 1000 determines a size of the union of the location history of the split-new tracker. The size of U_{T} is called sizeUnion. At 1008, the process 1000 determines a size of the current blob that is mapped to (or associated with) the split-new tracker. The size of the current blob mapped to the split-new tracker is called sizeCurr.

At 1010, the process 1000 determines if a first set of big object conversion conditions are met. For example, at 1010, it is determined if sizeUnion>T₁′ and sizeCurr>T₂′(T₁′>T₂′). If both conditions (sizeUnion>T₁′ and sizeCurr>T₂′) are met, the new tracker is converted to be a normal tracker at 1012. If both of the conditions are not met, the process 1000 determines at 1014 if the condition sizeCurr>T₂′ is met. If the condition sizeCurr>T₂′ is met, the waiting period for conversion is updated at 1016 to a fraction of the threshold duration T_{split-new} (e.g., half the threshold duration T_{split-new}, a third of T_{split-new}, or other factional amount), which can promote the tracker to a normal tracker faster. If both of the sizeUnion>T₁′ and sizeCurr>T₂′ conditions are not met, the process 1000 determines at 1018 if the condition sizeCurr>T₃ is met. If the condition sizeCurr>T₃ is met, the waiting period for conversion is updated at 1020 to a fraction of the threshold duration T_{split-new} (e.g., three-fourths of T_{split-new}, half the threshold duration T_{split-new}, or other factional amount). The fractional amount of the threshold duration T_{split-new} determined at 1020 is a larger duration than the fractional amount determined at 1016, leading to a longer waiting period at 1020.

As previously described, a size-based conversion method can also be performed to check if the object will be promoted to be a real object or not. For example, if the object size in the current frame is greater than T₅, a new or split-new tracker (and its associated object or blob) can be converted to normal immediately. The size-based conversion method can be performed independently or in combination with one or both of the huge blob conversion and big blob conversion methods.

The abnormal size change technique described above can also be performed independently or in combination with one or more of the huge blob conversion method, the big blob conversion method, and the size-based conversion method. The abnormal size change technique includes an abnormal size ratio conditional distance measurement that can be used in tracker-blob (or object) association (or mapping) to reject a mapping between a tracker-blob pair for which a size ratio is too small. For example, a size ratio

$${R}_{AB} = \frac{{Size}_{A ⋂ B}}{{Size}_{A ⋃ B}}$$

is introduced, as described above, with A as the bounding box of the current tracker and B as the bounding box of a blob detected in the current frame. A can also be looked at as the bounding box of the blob detected in the previous frame. If R_{AB}<T_{R}, the tracker-blob pair has a high probability that it is not a good match. In some cases, the cost (e.g., distance) between the tracker and the blob can be assigned with a large number, which will prevent the tracker from being matched with the blob or will cause the association between the tracker and blob to be discarded.

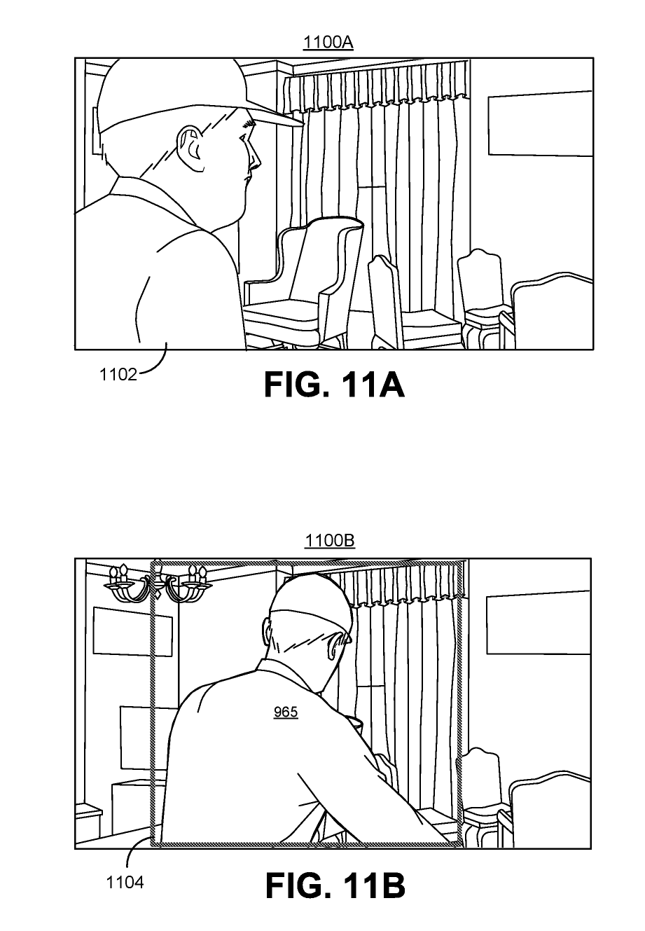

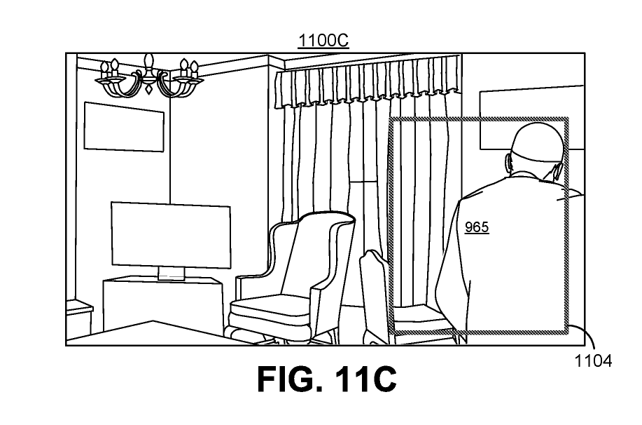

By considering the history of a tracker and the size of a blob associated with the tracker, a more intelligent tracking process can be performed. For example, larger objects (denoted herein as huge objects and big objects) can be tracked more quickly by the tracking engine. The content-adaptive blob tracking can be tested with an indoor video clip that captures a scene with challenging lighting changes and with large (e.g., huge or big) and fast moving objects that traditional tracking methods (e.g., using only a threshold duration T_{new} or _{Tsplit-new}) may not track before the object leaves the scene. FIG. 11A, FIG. 11B, and FIG. 11C show three video frames 1100A, 1100B, and 1100C of an environment in which a huge object 1102 is present. The huge object 1102 passes close to the camera and quickly moves through the field of view, as shown by the movement of the huge object 1102 across the three frames 1100A, 1100B, and 1100C. Traditional tracking methods that use only a threshold duration cannot catch the object to begin tracking it until the object passes through the scene from left to right. For example, if a vertical line is configured to detect line crossing events for the camera, the event of the object 1102 will not be detected since the object 1102 is not picked up when the object is passing the line. However, using the huge blob conversion technique described herein, the object 1102 can be output very early when it enters the field of view, as shown by the normal tracker 1104 in FIG. 11B and FIG. 11C. For example, the tracker 1104 can be a new tracker, and can be quickly converted to a normal tracker 1104 using huge blob conversion. The normal tracker 1104 is shown with tracker identifier (ID) 965.

FIG. 12A and FIG. 12B show two video frames 1200A and 1200B of an environment in which a big object 1202 is present. The big object 1202 is merged with the object 1204 (a set of curtains) in frame 1200A, and the merged object (including big object 1202 and object 1204) is tracked using tracker 1206. The big object 1202 is then split from the object 1204 in frame 1200B, in which case a merge-contained tracker 1208 (which is identified as a split-new tracker) is created due to the split from the container tracker 1206. Using the big object conversion technique described herein for a split-new tracker, the merge-contained tracker 1208 (for object 1202) that is split from the container tracker 1206 can be identified as split-new tracker and object, and is turned into a normal tracker quickly, as shown in FIG. 12B. The frame 1200A shows the object 1202 before it is split into two blobs. As shown in frame 1200B, the split-new object 1202 on the left can be identified as big object and converted to a normal tracker immediately.

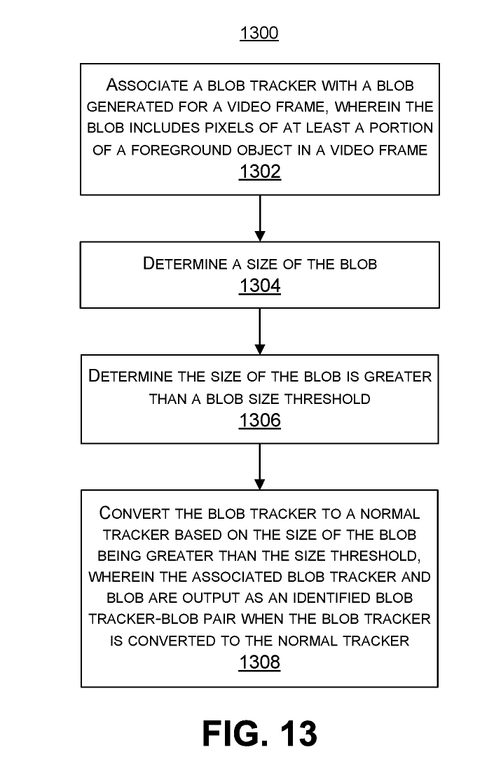

FIG. 13 illustrates an example of a process 1300 of tracking one or more blobs using the content-adaptive tracking techniques described herein. At 1302, the process 1300 includes associating a blob tracker with a blob generated for a video frame. The blob includes pixels of at least a portion of a foreground object in a video frame. For example, the blob tracker can be associated or matched with the blob using the data association engine 414 (e.g., based on a cost or distance between the blob tracker and the blob).

In some implementations, the process 1300 can include initiating a duration counter. When the duration counter is less than a duration limit, the blob tracker and the blob are a hidden or provisional blob tracker-blob pair. Should the duration counter reach the duration limit, the provisional blob tracker-blob pair would be output as an identified blob tracker-blob pair.

At 1304, the process 1300 includes determining a size of the blob. For example, the size of the blob can include the area of the bounding box of the blob or the number of pixels making up the blob.

At 1306, the process 1300 includes determining the size of the blob is greater than a blob size threshold. The blob size threshold can include any of the size thresholds described herein, such as any of the blob size thresholds T₂, T₂′, T₃, and T₅. In some implementations, the process 1300 determines that the size of the blob is greater than a blob size threshold prior to a duration counter reaching a duration threshold.

At 1308, the process 1300 includes converting the blob tracker to a normal tracker based on the size of the blob being greater than the size threshold. The associated blob tracker and blob are output as an identified blob tracker-blob pair when the blob tracker is converted to the normal tracker. In some implementations, step 1308 includes outputting the associated blob tracker and blob as a blob tracker-blob pair based on the size of the blob being greater than the blob size threshold.

In some examples, the process 1300 can perform the huge blob conversion and/or the big blob conversion. For example, the process 1300 can include determining a location history of the blob tracker. The location history includes one or more locations of one or more bounding boxes associated with the blob tracker in one or more previous video frames. In one illustrative example, at a specific time T, all of the bounding boxes Bᵢ (i=1, . . . , T) of the previously detected blobs associated with the blob tracker make up the location history of the split-new tracker. The process 1300 can further include determining a union of the one or more bounding boxes at the one or more locations. For example, the union of the location history of the split-new tracker can be the union of all the bounding boxes in the location history of the split-new tracker. The process 1300 can further include determining a size of the union of the one or more bounding boxes at the one or more locations is greater than a union size threshold. For example, the size of the union can be determined as described above with respect to FIG. 7, and can include the far corners of the outside bounding boxes of the bounding boxes in the location history. The process 1300 can further include converting the blob tracker to the normal tracker based on the size of the blob being greater than the size threshold and the size of the union of the one or more bounding boxes being greater than the union size threshold.

In some examples, the union size threshold is larger than the blob size threshold. For example, the blob size threshold can include a fraction of a frame size and the union size threshold can include a different fraction of the frame size. In one illustrative example, the union size threshold (denoted as T₁ or T₁′ above) can be set to half of the frame size, a quarter of the frame size, or other suitable fractional amount, and the blob size threshold (denoted as T₂ or T₂′ above) can be set to a fifth of the frame size, a sixth of the frame size, a tenth of the frame size, or other suitable fractional amount.

In some examples, the blob tracker includes a new tracker. When the blob tracker includes a new tracker, the union size threshold can include the threshold T₁ described above and the blob size threshold can include the threshold T₂ described above. In such examples, the process 1300 can perform the huge blob conversion. For example, the process 1300 can include determining a duration the blob tracker has been active. For example, the duration can include a duration since the blob tracker was created as a new tracker. The process 1300 can further include determining the duration is greater than an accelerated threshold duration. For example, as described above, the accelerated threshold duration (denoted as T_{accel} above) can be a duration that is shorter than a threshold duration (denoted as T_{new} above). For instance, the accelerated threshold duration is a fraction of a threshold duration for converting blob trackers with sizes not greater than the blob size threshold to normal trackers. The process 1300 can further include converting the blob tracker to the normal tracker based on the size of the blob being greater than the size threshold, the size of the union of the one or more bounding boxes being greater than the union size threshold, and the number of video frames being greater than the accelerated threshold duration.

In some examples, the blob tracker includes a split-new tracker. The split-new tracker is split from a parent blob tracker. When the blob tracker includes a split-new tracker, the union size threshold can include the threshold T₁′ described above and the blob size threshold can include the threshold T₂′ described above. In such examples, the process 1300 can perform the big blob conversion.

In some examples, the process 1300 can perform the size-based conversion described above. For example, the process 1300 can include determining a duration the blob tracker has been active and determining the duration is greater than a modified threshold duration. For example, as described above, the modified threshold duration (denoted as T_{mod} above) can be a shorter duration than the threshold durations T_{new} and T_{split-new}, and can be a longer duration than the accelerated threshold duration T_{accel} used for the huge blob conversion. In one illustrative example, the threshold duration T_{new} can be 30 frames, the accelerated threshold duration T_{accel} (e.g., T_{new}/5) can be 6 frames, and the modified threshold duration T_{mod} (e.g., T_{new}/3) can be 10 frames. The process 1300 can further include converting the blob tracker to the normal tracker based on the size of the blob being greater than the size threshold and the number of video frames being greater than the modified threshold duration.

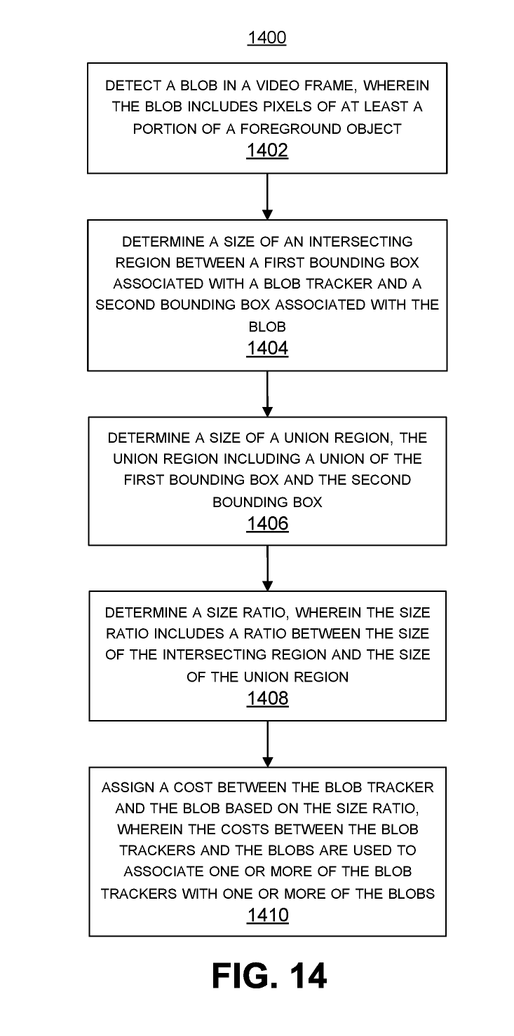

FIG. 14 illustrates an example of a process 1400 of determining costs between blob trackers and blobs using the abnormal size change detection techniques described herein. At 1402, the process 1400 includes detecting a blob in a video frame. The blob includes pixels of at least a portion of a foreground object.

At 1404, the process 1400 includes determining a size of an intersecting region between a first bounding box associated with a blob tracker and a second bounding box associated with the blob. At 1406, the process 1400 includes determining a size of a union region, the union region including a union of the first bounding box and the second bounding box. The size of the intersecting region and the size of the union region can be determined as described above with respect to FIG. 6 and FIG. 7. At 1408, the process 1400 includes determining a size ratio. The size ratio includes a ratio between the size of the intersecting region and the size of the union region (denoted as above).

$${R}_{AB} = \frac{{Size}_{A ⋂ B}}{{Size}_{A ⋃ B}}$$

At 1408, the process 1400 includes assigning a cost between the blob tracker and the blob based on the size ratio. The costs between the blob trackers and the blobs are used to associate one or more of the blob trackers with one or more of the blobs. For example, the process 1400 can include determining the size ratio is less than a size change threshold, and assigning the cost as a maximum cost value when the size ratio is less than the size change threshold. The maximum cost value prevents the blob tracker from being associated with the blob. In another example, the process 1400 can include determining the size ratio is greater than a size change threshold, determining a physical distance between the blob tracker and the blob, and assigning the cost as the determined distance. The process 1400 can then associate the blob tracker with the blob based on the cost.

In some examples, the processes 800, 900, 1000, 1300, and 1400 may be performed by a computing device or an apparatus, such as the video analytics system 100. For example, the processes 800, 900, 1000, 1300, and 1400 can be performed by the object tracking engine 606 shown in FIG. 6, the blob tracker update engine 516 shown in FIG. 5, or a combination thereof. In some cases, the computing device or apparatus may include a processor, microprocessor, microcomputer, or other component of a device that is configured to carry out the steps of processes 800, 900, 1000, 1300, and 1400. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Processes 800, 900, 1000, 1300, and 1400 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 800, 900, 1000, 1300, and 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The content-adaptive blob tracking operations discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method of tracking one or more blobs, the method comprising:
associating a blob tracker with a blob generated for a video frame, wherein the blob includes pixels of at least a portion of a foreground object in the video frame;
determining a size of the blob;
prior to a duration counter reaching a duration threshold, determining the size of the blob is greater than a blob size threshold; and
outputting the associated blob tracker and blob as a blob tracker-blob pair based on the size of the blob being greater than the blob size threshold.

2. The method of claim 1, further comprising:
determining a location history of the blob tracker, wherein the location history includes one or more locations of one or more bounding boxes associated with the blob tracker in one or more previous video frames;
determining a union of the one or more bounding boxes at the one or more locations; and
determining a size of the union of the one or more bounding boxes at the one or more locations is greater than a union size threshold;
wherein outputting the blob tracker and the blob as a blob tracker-blob pair is further based on the size of the union of the one or more bounding boxes being greater than the union size threshold.

3. The method of claim 2, wherein the union size threshold is larger than the blob size threshold.

4. The method of claim 2, further comprising:
determining a duration the blob tracker has been active; and
determining the duration is greater than an accelerated threshold duration;
wherein outputting the blob tracker and the blob as a blob tracker-blob pair is further based on the duration being greater than the accelerated threshold duration.

5. The method of claim 4, wherein the accelerated threshold duration is a fraction of the duration threshold.

6. The method of claim 1, further comprising:
determining a duration the blob tracker has been active; and
determining the duration is greater than a modified threshold duration;
wherein outputting the blob tracker and the blob as a blob tracker-blob pair is further based on the duration being greater than the modified threshold duration.

7. The method of claim 1, wherein the blob size threshold includes a fraction of a frame size.

8. The method of claim 1, further comprising:
identifying the blob tracker as a new blob tracker, wherein the identifying is based on the blob tracker having been generated for the video frame.

9. The method of claim 1, further comprising:
determining a first blob tracker and a first blob, wherein the first blob is generated for the video frame, and wherein the first blob tracker is associated with the first blob;
determining the blob to be associated with the first blob tracker, wherein associating the blob tracker with the blob is based on the blob being associated with the first blob tracker, and wherein the blob includes information provided by the first blob trackerl.

10. The method of claim 1, further comprising:
determining a location history of the blob tracker, wherein the location history includes one or more locations of one or more bounding boxes associated with the blob tracker in one or more previous video frames;
determining a union of the one or more bounding boxes at the one or more locations; and
upon determining a size of the union of the one or more bounding boxes at the one or more locations is less than a union size threshold:
determining a duration the blob tracker has been active; and
determining the duration is greater than a modified threshold duration;
wherein outputting the blob tracker and the blob as a blob tracker-blob pair is further based on the duration being greater than the modified threshold duration.

11. An apparatus comprising:
a memory configured to store video data; and
a processor configured to:
associate a blob tracker with a blob generated for a video frame, wherein the blob includes pixels of at least a portion of a foreground object in a video frame;
determine a size of the blob;
determine the size of the blob is greater than a blob size threshold; and
convert the blob tracker to a normal tracker based on the size of the blob being greater than the size threshold, wherein the associated blob tracker and blob are output as an identified blob tracker-blob pair when the blob tracker is converted to the normal tracker.

12. The apparatus of claim 11, wherein the processor is further configured to:
determine a location history of the blob tracker, wherein the location history includes one or more locations of one or more bounding boxes associated with the blob tracker in one or more previous video frames;
determine a union of the one or more bounding boxes at the one or more locations;
determine a size of the union of the one or more bounding boxes at the one or more locations is greater than a union size threshold; and
convert the blob tracker to the normal tracker based on the size of the blob being greater than the size threshold and the size of the union of the one or more bounding boxes being greater than the union size threshold.

13. The apparatus of claim 12, wherein the union size threshold is larger than the blob size threshold.

14. The apparatus of claim 12, wherein the blob tracker includes a new tracker.

15. The apparatus of claim 12, wherein the blob tracker includes a split-new tracker, the split-new tracker being split from a parent blob tracker.

16. The apparatus of claim 12, wherein the processor is further configured to:
determine a duration the blob tracker has been active;
determine the duration is greater than an accelerated threshold duration; and
convert the blob tracker to the normal tracker based on the size of the blob being greater than the size threshold, the size of the union of the one or more bounding boxes being greater than the union size threshold, and the number of video frames being greater than the accelerated threshold duration.

17. The apparatus of claim 16, wherein the accelerated threshold duration is a fraction of a threshold duration for converting blob trackers with sizes not greater than the blob size threshold to normal trackers.

18. The apparatus of claim 11, wherein the processor is further configured to:
determine a duration the blob tracker has been active;
determine the duration is greater than a modified threshold duration; and
convert the blob tracker to the normal tracker based on the size of the blob being greater than the size threshold and the number of video frames being greater than the modified threshold duration.

19. The apparatus of claim 11, wherein the blob size threshold includes a fraction of a frame size.

20. A computer readable medium having stored thereon instructions that when executed by a processor perform a method, including:
associating a blob tracker with a blob generated for a video frame, wherein the blob includes pixels of at least a portion of a foreground object in a video frame;
determining a size of the blob;
determining the size of the blob is greater than a blob size threshold; and
converting the blob tracker to a normal tracker based on the size of the blob being greater than the size threshold, wherein the associated blob tracker and blob are output as an identified blob tracker-blob pair when the blob tracker is converted to the normal tracker.

21. The computer readable medium of claim 20, the method further comprising:
determining a location history of the blob tracker, wherein the location history includes one or more locations of one or more bounding boxes associated with the blob tracker in one or more previous video frames;
determining a union of the one or more bounding boxes at the one or more locations;
determining a size of the union of the one or more bounding boxes at the one or more locations is greater than a union size threshold; and
converting the blob tracker to the normal tracker based on the size of the blob being greater than the size threshold and the size of the union of the one or more bounding boxes being greater than the union size threshold.

22. The computer readable medium of claim 21, wherein the union size threshold is larger than the blob size threshold.

23. The computer readable medium of claim 21, wherein the blob tracker includes a new tracker.

24. The computer readable medium of claim 21, wherein the blob tracker includes a split-new tracker, the split-new tracker being split from a parent blob tracker.

25. The computer readable medium of claim 21, further comprising:
determining a duration the blob tracker has been active;
determining the duration is greater than an accelerated threshold duration; and
converting the blob tracker to the normal tracker based on the size of the blob being greater than the size threshold, the size of the union of the one or more bounding boxes being greater than the union size threshold, and the number of video frames being greater than the accelerated threshold duration.

26. The computer readable medium of claim 25, wherein the accelerated threshold duration is a fraction of a threshold duration for converting blob trackers with sizes not greater than the blob size threshold to normal trackers.

27. The computer readable medium of claim 20, further comprising:
determining a duration the blob tracker has been active;
determining the duration is greater than a modified threshold duration; and
converting the blob tracker to the normal tracker based on the size of the blob being greater than the size threshold and the number of video frames being greater than the modified threshold duration.

28. The computer readable medium of claim 20, wherein the blob size threshold includes a fraction of a frame size.
